(19) United States
(12) Patent Application Publication
(10) Pub. No.: US 2025/0292302 A1
(43) Pub. Date: Sep. 18, 2025

(54) DYNAMIC GENERATIVE SKILLS AGENTS USING LARGE LANGUAGE MODELS

(71) Applicant: Bluecore, Inc., New York, NY (US)

(72) Inventors: Max Bennett, Brooklyn, NY (US); Kenny Teng, Brooklyn, NY (US); Daniel Stekol, New York, NY (US)

(21) Appl. No.: 19/227,155

(22) Filed: Jun. 3, 2025

Related U.S. Application Data
(63) Continuation-in-part of application No. 18/589,343, filed on Feb. 27, 2024.
(60) Provisional application No. 63/542,995, filed on Oct. 6, 2023.

(51) Int. Cl. G06Q 30/0601; G06N 3/042; G06Q 30/0282

(52) U.S. Cl. CPC G06Q 30/0625; G06N 3/042; G06Q 30/0282; G06Q 30/0631

(57) ABSTRACT

Exemplary embodiments include systems and methods for generating dynamic searches and responses for a customer of an ecommerce store, the systems and methods comprising: a source database storing context information regarding products listed on the ecommerce store; a user interface element supported by the ecommerce store, configured to receive a prompt-query pair comprising a user query and a pre-configured prompt, and further configured to populate a contextual response to the prompt-query pair; a server coupled to the user device; and a large language model coupled to the source database and the server. The large language model is configured to: generate an initial set of prompt-query pairs using context information for products listed on the ecommerce store; receive the prompt-query pair; and generate a contextual response using the pre-configured prompt and the information regarding the product stored in the at least one source database.

### CROSS REFERENCE TO RELATED APPLICATIONS

The present application is a Continuation in Part and claims the priority benefit of U.S. patent application Ser. No. 18/589,343, filed on Feb. 27, 2024, titled “Dynamic Frequently Asked Questions Using Large Language Models”, which claims the priority benefit of U.S. Provisional Patent Application Ser. No. 63/542,995, filed on Oct. 6, 2023, titled “Personalized Frequently Asked Questions Using Large Language Models”. This application is related to U.S. patent application Ser. No. ______, titled “System and Method for Enhancing On-line Browsing Using Automated Agents”, which is a Continuation in Part and claims the priority benefit of U.S. patent application Ser. No. 18/518,286, filed on Nov. 22, 2023, titled “System and Method for Simplifying On-Line Browsing on Websites Using Embeddable Clickable Prompt Buttons”. These applications are hereby incorporated by reference in their entirety, including all appendices.

### FIELD OF THE TECHNOLOGY

Embodiments of the disclosure relate to Large Language Models, and in particular, but not by limitation, to their application in generating responses to queries for product information. Further embodiments relate to use of generative queries and responses to optimize sales on e-commerce platforms.

### SUMMARY OF EXEMPLARY EMBODIMENTS

Embodiments of the disclosure include systems and methods for generating dynamic search requests and responses for a customer of an e-commerce store. An exemplary system comprises: at least one source database storing context information regarding one or more products listed on the ecommerce store; at least one user interface element supported by the ecommerce store, the user interface element displayable on a graphical user interface on a user device and configured to receive at least one user query and further configured to populate at least one contextual response to the user query; at least one server comprising at least one processor and memory for storing instructions executable on the processor, the at least one server communicatively coupled to the user device over a network connection; and at least one large language model communicatively coupled to the at least one source database and the at least one server, the at least one large language model being trained using data stored in the at least one source database.

The at least one large language model is configured to: generate an initial set of at least one prompt-query pair using the context information for each of the one or more products listed on the ecommerce store; receive the at least one user query from the user device, the user query comprising a user selection of a query, the query being associated with at least one pre-configured prompt for the at least one large language model; generate and display the contextual response to the prompt-query pair using the pre-configured prompt, the at least one user query, and the information regarding the product stored in the at least one source database.

In various embodiments, the dynamic search requests include any of the following: frequently asked questions; product comparisons; summaries of customer reviews; suggested co-purchases; and lists of best-selling products.

In various embodiments, the user interface element comprises any of the following: a webpage component, a mobile application component, and a web component displayed in the body of an email.

In some embodiments, the at least one prompt-query pair being submitted as any one of: a clickable link having the text of the at least one product-related query, and a plain text query generated by the user.

In some embodiments, the systems and methods further comprise a conversation agent configured to record a customer's browse behavior on an ecommerce store and an identifier of the customer. In such embodiments, the large language model further configured to generate the contextual response to the at least one user query and the follow-up question based on the customer's browse behavior and the identifier as recorded by the conversation agent. In alternative embodiments, the server stores and retrieves the customer's browse behavior, history, and identifier in the source database.

Some embodiments further comprise a caching means communicatively coupled to the server, the caching means configured to cache prompt-query pairs and their associated contextual responses; and a retrieval unit configured to fetch cached the contextual responses and display them without invoking the large language model.

In some embodiments, the large language model is trained, at least in part, by collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer-posted questions and answers to the customer-posted questions from other customers or from online sellers.

The collected training data is processed to create training prompts simulating real-world scenarios where a hypothetical customer seeks product-related information based on the hypothetical customer's history and context. The large language model is trained using the training prompts to predict most likely queries the hypothetical customer might have about a product. In some embodiments, the large language model's predictions are refined using feedback received from actual customer interactions on the ecommerce store.

In some embodiments, the training data further comprises customer browse behavior, customer context information, and customer queries related to one or more of the products.

In some embodiments, the large language model is further configured to generate a plurality of prompt-query pairs and a subset within the plurality of the prompt query pairs, the subset to be displayed within the user interface element. Some such embodiments include a scoring means for determining an optimal set of queries to feature as the subset within the plurality of prompt-query pairs, the determination being based at least in part on input comprising at least one of: sales trends, browse rate, click rate, add-to-cart rate, remove-from-cart rate, browse-to-purchase ratio, and click-to-purchase ratio, as well as other conversion and drop-off rates.

In some embodiments, the scoring means comprises a deep neural network configured to receive the input at a first input layer; process the input by one or more hidden layers; generate a first output; transmit the first output to an output layer; generate a first outcome comprising the determining of the optimal set of questions; and transmitting the first outcome to the input layer as further input.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an example system that comprises various modules that can be executed to provide the FAQ features described herein.

FIG. 2 is an example screenshot of a webpage and application providing the LLM-based FAQ.

FIG. 3 presents an exemplary deep neural network.

FIG. 4 diagrammatically illustrates a method for determining optimal subsets of LLM-based FAQs to post on a webpage.

FIG. 5 is a further example screenshot of a webpage and application providing the LLM-based generative questions and answers.

FIGS. 6A and 6B depict a further example of a webpage and application providing the LLM-based generative questions and answers.

FIG. 7 diagrammatically illustrates various exemplary embodiments of skills agents.

### DETAILED DESCRIPTION OF EXEMPLARY EMBODIMENTS

Exemplary embodiments of the present disclosure incorporate skills agents. Skills agents are comprised of interactive software or web components on a website. Skills agents transmit prompt-based queries to at least one Large Language Model and receive a response from the at least one Large Language Model. In some embodiments, each skill agent is coupled to one Large Language Model or to its own network of Large Language Models. In alternative embodiments, multiple skill agents transmit and receive from the same Large Language Model or network of Large Language Models.

One type of skill agent is Generative Q&A, which uses Large Language Models to generate frequently asked questions and answers to pair with the frequently asked questions. Other skill agents include Generative Review Summaries; Generative Comparisons; Generative Co-Purchases; and Generative Best Sellers, among other tools.

Customers often have questions about products before a purchase is made. However, brands cannot easily answer every question, because it is expensive to have humans available online to answer each of these questions. Many customers do not want to go through the belabored process of opening a live chat and waiting for a person to respond. Furthermore, many customer care agents are not actually product experts and often do not have the right answers to many of these questions.

One solution is to place a list of “frequently asked questions” on a product detail page in order to anticipate customer questions and answer them directly. However, this has several example problems. First, it is very time consuming and expensive to have employees write these “FAQs” on every product, and second, it is hard to predict what the actual most likely questions will be.

There are almost always too many questions, and too great a diversity of questions, to put all of them on the page. This would make the experience of the product detail page too busy.

To solve these challenges, Large Language Models can be used to automatically predict and generate questions and answers for each individual customer when they land on a product detail page.

As used herein, the term language model generally refers to a probability distribution over sequences of words. Language models generate probabilities by training on large and structured sets of text, or text corpora. A single text corpus may include a single language or many languages, and may have various levels of structure based on, for example, grammar, syntax, morphology, semantics, and pragmatics.

A Large Language Model, or LLM, refers to a language model consisting of a deep learning architecture that is trained on large quantities, often tens of gigabytes, of unlabeled text using self-supervised learning or semi-supervised learning to produce generalizable and adaptable output. The deep learning architecture may be comprised of a neural network with billions of weights or parameters. In some embodiments, the neural network may be a transformer, which uses parallel multi-head attention mechanism, or alternatively the neural network may be recursive, operating in sequence.

Additionally, in some embodiments, the Large Language Model is communicatively coupled with one or more source databases.

In some embodiments, frequently asked questions are generated by large language models using contextual information regarding a product or service for sale on an ecommerce store. In some of these and alternative embodiments, these frequently asked questions comprise question-answer pairs, featuring the frequently asked question and the answer to the frequently asked question. In some embodiments, both the frequently asked question and the answer to which it is paired are generated using a large language model.

As used herein, “ecommerce store” generally includes online sales platforms such as web stores, including any website, mobile app, or other digital platform where goods or services are sold or advertised. “Product” as used herein includes goods and services listed for sale in an ecommerce store. “Products” generally includes goods listed for sale or advertised, as well as services such as hotel or vacation stays, leisure activities, professional services, and other types of services, non-exhaustively. Platforms are generally supported as websites accessible by web browser or in a native application on a computer or smart device.

In some embodiments, the frequently asked questions and question-answer pairs are displayed in a widget or web component within a product detail page on the web platform. However, the questions and question-answer pairs are configurable to be displayed in various display components of a website, including product lists, online shopping cart pages, and checkout pages, non-exhaustively.

The contextual information is drawn from one or more data sources in one or more source databases, which include, in exemplary embodiments: product details posted on a page in the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers.

Additional data sources include data regarding the sales of a product, including purchase history and trends; and ratios such as browse-to-purchase ratio, or conversion rate.

In some embodiments, the system generates a large number of usable questions or question-answer pairs and subsequently determines an optimal subset to display to a user. In one such example, the LLM generates fifty question-answer pairs, and the system predicts which five of the fifty questions are most likely to be useful to shoppers. In some embodiments, the determination is made algorithmically based on metrics such as word frequency in positive reviews or frequently clicked FAQs in an iterative process.

In further embodiments, the system uses machine learning methods featuring one or more neural networks trained and tuned for precision using information related to contextual information regarding a product.

In some embodiments, a click on one or more frequently asked questions generates a new list of related frequently asked questions within the online display.

By way of example, using the systems and methods disclosed herein, a customer of an ecommerce store clicks one frequently asked question link. The customer click causes the system to send a prompt to at least one LLM. An exemplary prompt reads:
“You are a salesperson product expert for {{online seller}}. Answer the following question: {{question}} based on the following contextual information: {{insert contextual information}};
“Provide a list of exactly {{number of questions to generate}} additional questions the customer might ask.”

While this document generally refers to skills agents comprising web components on an e-commerce web page, it should be noted that further embodiments for web components comprising skills agents are enabled. In some exemplary embodiments, skills agents are deployed as widgets in a mobile application or in the body of an email received by an actual or potential customer of the e-commerce store. In some such embodiments, skills agents generate prompt-query pairs and associated responses within the body of the email and without opening a new webpage.

In addition to Generative Q&A, a further example of a skill agent is Generative Comparison. In various embodiments, Generative Comparison quickly compares products with criteria that are important to one or more customers.

In an exemplary embodiment, one or more widgets for the Generative Comparison skill are displayed on a website. The Generative Comparison widgets indicate, generally in plain text, a feature for comparison between the present product and at least one related product, for example: “Compare this to other beginner skis”, or “Show me similarly priced shoes”.

When a customer clicks on the widget, a prompt is submitted to the Large Language Model. An exemplary prompt reads: “Generate a comparison table having five columns with this product in the first column and similar products in the subsequent four columns. The table must include rows having categorized data to compare each product to the other products. The categorized data should include {{category; for example, price, skill level, size, primary purpose, specifications, or unique features}}.”

The LLM draws from a database associated with the e-commerce store, the database containing data for the purchase history on the e-commerce store. The purchase history as stored in the database includes product purchases, total checkout packages (which products were purchased together in single transactions), and customer history (which products were purchased by the same customers in prior or subsequent transactions). The database also includes product information, such as price, skill level, size, primary purpose, specifications, or unique features.

A further example of a skill agent is Generative Review Summaries. In various embodiments, Generative Review Summaries aggregates key sentiments to provide an overview of customer feedback on a product.

In some embodiments, customers on a user's website click on a widget that indicates the Generative Review Summaries skill. For example, a widget might have “Summarize Reviews for Me” or “What do customers say?” displayed in plain text. When the customer clicks on the widget, a prompt is submitted to the Large Language Model. An exemplary prompt reads:

“Summarize the reviews on the product page for this product: {{link to reviews on product page}}.”

Exemplary prompts are further tailored according to the user's preferences. For example, an e-commerce seller indicates one or more subsets of reviews to be summarized, such as the most positively reviewed, the most popular reviews according to user feedback, or verified purchases only:

“Summarize the four-star or five-star reviews on the product page for this product: {{link to reviews on product page.}}”

“Summarize the ten most popular reviews, based on the user feedback from the ‘Was this Helpful’ link, on the product page for this product: {{link to reviews on product page}}.”

“Summarize the reviews from verified purchasers on the product page for this product: {{link to reviews on product page}}. Do not include reviews from accounts that are not verified purchasers.”

In further exemplary embodiments, additional features and limitations of a review summary are included in the prompt, such as “Include at the end of the summary the number of reviews that were used to generate the summary and the average rating from each review.”

The LLM draws from a database including customer data, product reviews in plain text, product ratings, and other features of reviews, such as whether the review was left by a verified purchaser.

A further example of a skill agent is Generative Co-Purchase. In various embodiments, Generative Co-Purchase lists other products on an e-commerce store that are commonly purchased together.

In some embodiments, customers on a user's website click on a widget that indicates the Generative Co-Purchase skill. In some embodiments, the widget displays plain text, such as “What do customers typically buy with this?” When the customer clicks on the widget, a prompt is submitted to the Large Language Model. An exemplary prompt reads:

“Review purchases that include {{product}} and generate a list of the five products that are most commonly purchased in the same checkout transaction as {{product}}. The list should be in order from the most commonly purchased item to the least commonly purchased item.”

The LLM draws from a database associated with the e-commerce store, the database containing data for the purchase history on the e-commerce store. The purchase history as stored in the database includes total purchases of individual products, total checkout packages that included each product (i.e., which products were purchased together in single transactions), and customer history (which products were purchased by the same customers in prior or subsequent transactions), among other data.

A further example of a skill agent is Generative Best Sellers. In various embodiments, Generative Best Sellers returns best selling products in the same category as one or more products in an e-commerce store.

In some embodiments, customers on a user's website click on a widget that indicates the Generative Best Sellers skill. For example, a widget reads in plain text: “What are your best-selling dresses?” When the customer clicks on the widget, a prompt is submitted to the Large Language Model. An exemplary prompt reads:

“Generate a list of five products in this category: {{For example: Dresses}} and rank each product from the highest number of sales to the lowest number. Each entry on the list should include a thumbnail image of the product and the product name.”

The LLM draws from a database associated with the e-commerce store, including the purchase history. The purchase history as stored in the database includes total number of sales, the time and date of each sale, the place of purchase and place of shipment for each sale, among other data. In various embodiments, the LLM constructs responses with time-bounded total number of sales (for example, the best-selling products of last year, or the best-selling products of this past year) or regional total sales (for example, best-selling products in the continental United States, or best-selling products in Europe).

In various embodiments, prompts are tailored to limit the types of contextual responses that can be displayed. An exemplary prompt includes: “Do not include reviews that use obscene or derogatory language. Do not include reviews that describe another company's product.”

In various embodiments, each skill agent encapsulates an underlying function, a data dependency, and a system for generating initial prompts. As used herein, an underlying function generally refers to a tool or application plugin interface (API) with which the agent can send a request to obtain information. Data dependency refers to the system using at least one database having data from which to generate a response—for example, review content to generate reviews.

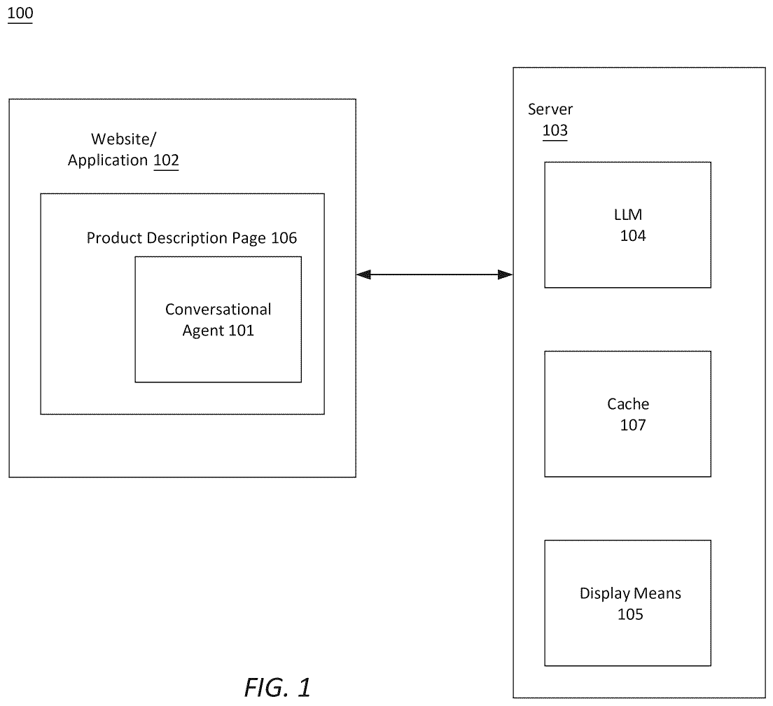

FIG. 1 is an example system that comprises various modules that can be executed to provide the FAQ features described herein. The system 100 includes a tracking means configured to record activity related to a product listed by an ecommerce store interfaced on a website or application 102. Such products are generally listed on a web page 106, but may also be depicted in, for example, home pages, lists of related products, online shopping carts, and checkout pages. In the exemplary embodiment, the system includes a server 103 configured to receive information collected from the tracking means. The system further includes an LLM 104 receiving input from the server and producing a set of questions based on information collected from the tracking means. The LLM produces a set of questions based on the information collected from the tracking means and the product details. In some embodiments, the system further comprises a display means 105, (graphical user interface generator) configured to show the questions in a widget on, for example, the product detail page 106 of the website or application 102. In some embodiments, the server 102 includes a caching unit 107 configured to store responses from the LLM for previously answered questions and fetch cached answers. The system may thus display question-answer pairs in some cases without the need to invoke the LLM.

Some exemplary embodiments include customer-specific tracking means. In some such embodiments, the system 100 includes a tracking means (such as a conversational agent 101) configured to record a customer's browse behavior on a brand's website or application 102. The server 103 is configured to receive the customer's browse behavior and an identifier of the customer and to retrieve additional customer context information. The LLM 104 receives input from the server and produces a set of questions based on the customer's history and product details.

In some embodiments, a brand places a widget in a div tag on their product detail page where dynamic FAQs will be populated. In customer-specific embodiments, JavaScript tracks a customer's browse behavior on the brand's website within that session (either in an application or on a website), which includes: Pages visited (products viewed, articles read, and so forth); Actions taken (searching, adding to cart); and Messages sent (any previous conversations with a chat system).

In some embodiments, when a customer lands on a product detail page (PDP), a request is made that contains all of the customer's browse behavior and an identifier of the customer to a server. This server can also look up information on that customer such as previous order history, loyalty information, and further information. The server then passes this information to an LLM that has been trained to predict the most likely questions a customer will ask given their historical behavior.

An example prompt could be as follows:
A customer on {{website}} just viewed the following actions:
{{visit and action history}}
Here is some context on this customer:
{{customer purchase history}}

The customer is now on the page for {{product name}}. Please provide the three most likely questions a customer will have about this product, given their history. These questions are then presented in the div on the product detail page.

If the customer clicks on the question, then it makes another request to the server to the normal question-answer LLM that then answers the customer question. In some embodiments, the system can cache responses so if someone ever asks the same question on product, then it can respond with the answer in real time, without computing the answer.

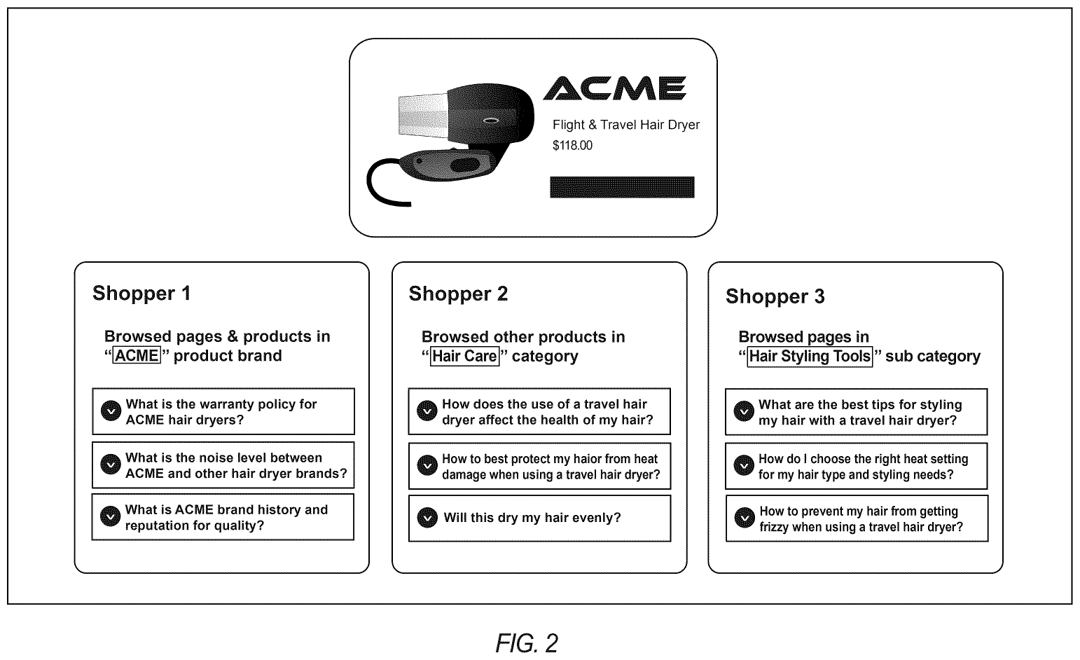

FIG. 2 is an example screenshot of a webpage and application providing the LLM-based FAQ. As illustrated, the system generates example questions based on product information from data sources including, for example: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers.

Additional data sources include data regarding the sales of a product, including purchase history and trends; and ratios such as browse-to-purchase ratio, or conversion rate.

In some embodiments, the system generates example questions based on the collected browsing history of the user (as well as other information discussed herein). As noted above, if the customer clicks on the question, then it makes another request to the server to the normal question-answer LLM that then answers the customer question.

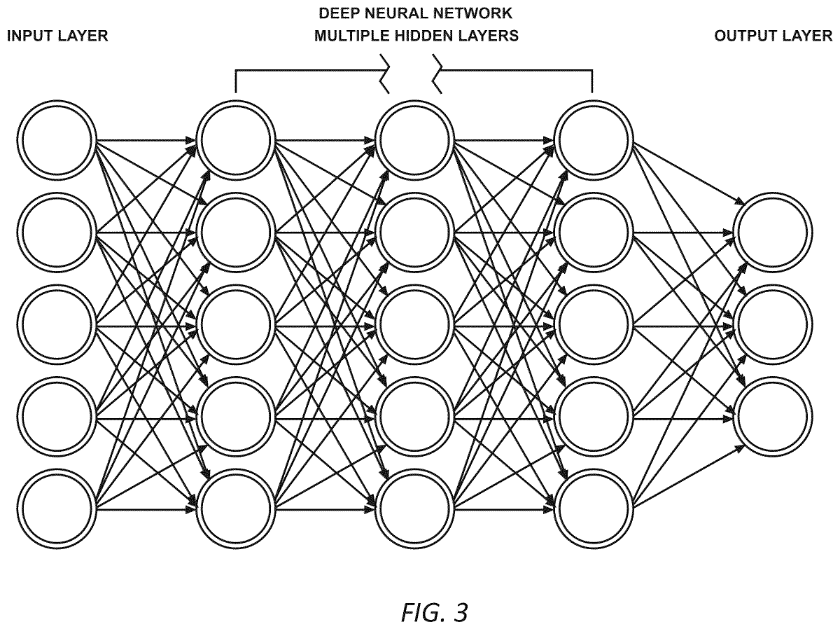

FIG. 3 shows an exemplary deep neural network. Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

According to some exemplary embodiments, the system produces an output, which in turn produces an outcome, which in turn produces an input. In some embodiments, the output may become the input. Deep Neural Networks can be used to support Large Language Models, or LLMs.

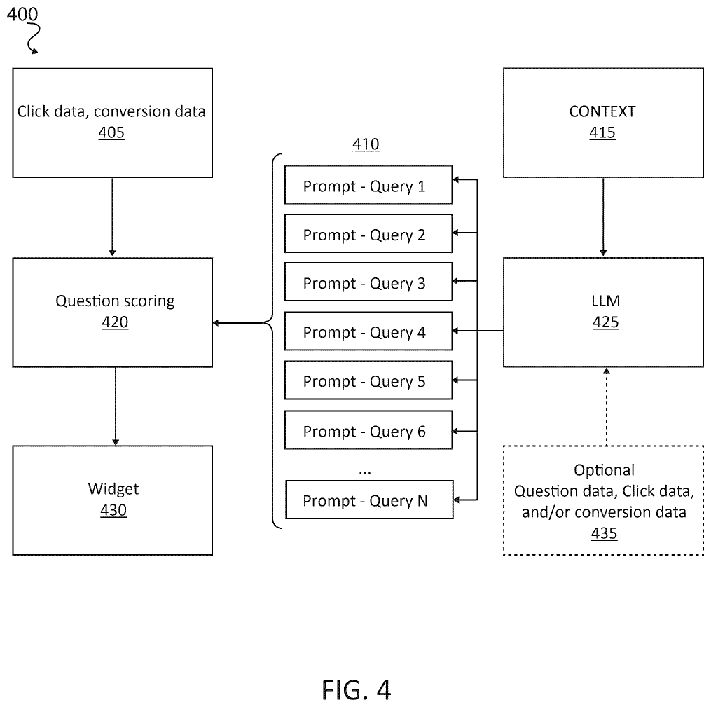

FIG. 4 diagrammatically illustrates a method for determining optimal subsets of LLM-based skills agents to post on a webpage. An LLM 425 generates a plurality of predicted initial predicted queries 410 for a generative skill agent section in a widget 430, or user interface element, in an ecommerce store. The LLM draws from at least one database having context 415 about one or more products listed by the ecommerce store, and in some embodiments, draws from question data, click data, and/or conversion data 435. A scoring agent 420 determines an optimal subset of prompt-query pairs from the plurality of initial predicted queries 410 to be listed in the widget 430.

In some embodiments, each initial predicted query comprises a prompt-query pair. Each prompt-query pair includes a query displayed on a web component on a product page, generally in plain text, that indicates a standard customer request for information. For Generative Review Summaries, an exemplary query reads “Summarize reviews for me”.

It should be noted that plain text is not necessary to denote a Generative Skill Agent. In some embodiments, a symbol, graphical image, or single word like “Summarize” located proximally to a review section of a webpage is sufficient to denote a query in a prompt-query pair.

Each prompt-query pair further includes a prompt. In various embodiments, the prompt itself is generated from a Large Language Model that is trained on data from at least one source database.

In some embodiments, prompts are further tailored for precision, specificity, and scope. For example, while a query in a query-prompt pair simply reads “Summarize positive reviews for me”, an exemplary prompt in the prompt-query pair reads:

“Summarize the four-star and five-star reviews received within the past six months from verified purchasers on the product page for this product: {{link to reviews on product page}}. Do not include reviews from accounts that are not verified purchasers.”

In some embodiments, the scoring agent 420 bases its determination at least in part on input comprising at least one of: sales trends, browse rate, click rate, add-to-cart rate, remove-from-cart rate, browse-to-purchase ratio, and click-to-purchase ratio, as well as other conversion and drop-off rates. In some embodiments, the scoring agent 420 applies a penalty to the prompt-query score for clicks, browses, and removals from cart where no sale is the result.

The scoring agent 420 may, for example, determine that “Summarize positive reviews for me” results in more overall sales, more overall conversions from clicks and browses to purchases, or both, than a similar query, like “Summarize all reviews” or “Summarize reviews from the past six months”. In such a case, the scoring agent 420 will score “Summarize positive reviews” more highly than the others and push it into the subset of optimal queries for display on the webpage.

In exemplary embodiments, similar processes are followed for other skills agents described herein. In one example for Generative Comparisons, the system generates a plurality of comparison questions, such as “Compare with others like this”, “Compare with other {beginner, intermediate} products like this”, and “Compare with other {shirts, boots, equipment} in size {small, medium, large}”. The scoring agent 420 determines which Generative Comparison queries produce optimal sales results and pushes those queries into the subset to be displayed on the website.

In some embodiments, the scoring agent 420 is implemented deep neural network configured to receive the input at a first input layer; process the input by one or more hidden layers; generate a first output; transmit the first output to an output layer; generate a first outcome comprising the determining of the optimal set of questions. In some embodiments, the first outcome is transmitted back to the input layer as further input.

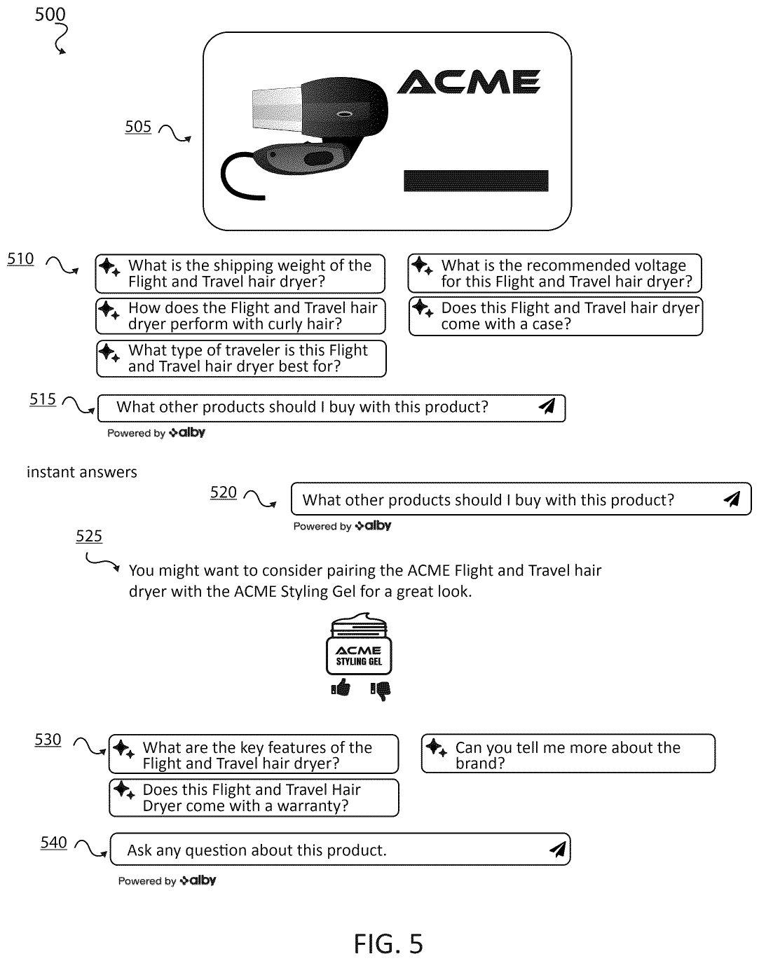

FIG. 5 is a further example screenshot of a webpage and application providing the LLM-based generative questions and answers. An ecommerce store hosts a widget having pre-determined FAQs 510 related to a product 505 and prepared by an LLM trained on data related to the product. In this embodiment, the pre-determined FAQs 510 are presented in clickable format, where a customer clicks a question to generate an answer 525 prepared by the LLM. Alternatively, the customer submits a plain text query 515 to the LLM to generate the answer 525. In some embodiments, the widget displays the question as repeated 520 along with the answer 525.

Along with the answer 525, in some embodiments, the LLM generates one or more follow-up questions 530 related to the product. In this exemplary embodiment, a follow-up prompt to ask any question 540 is also presented.

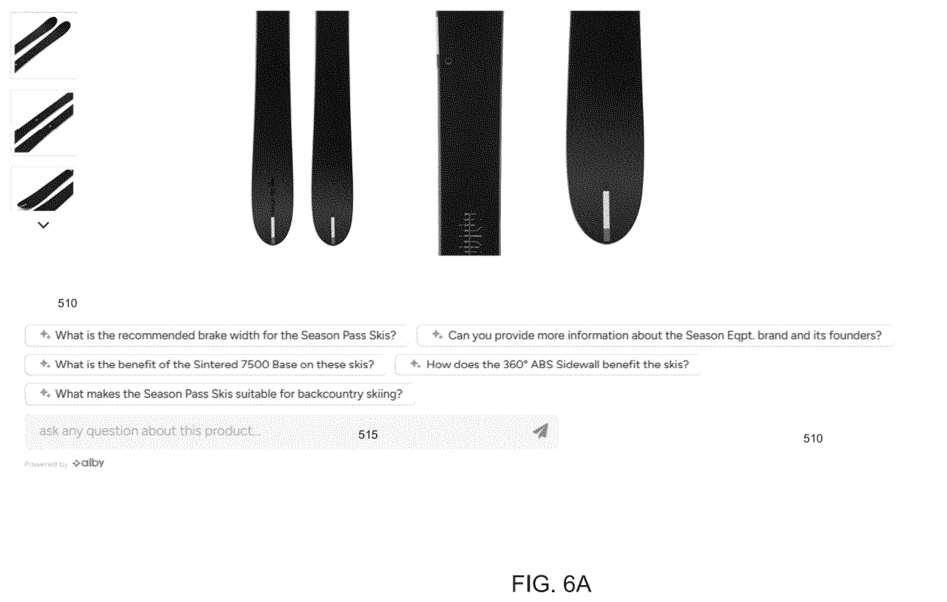

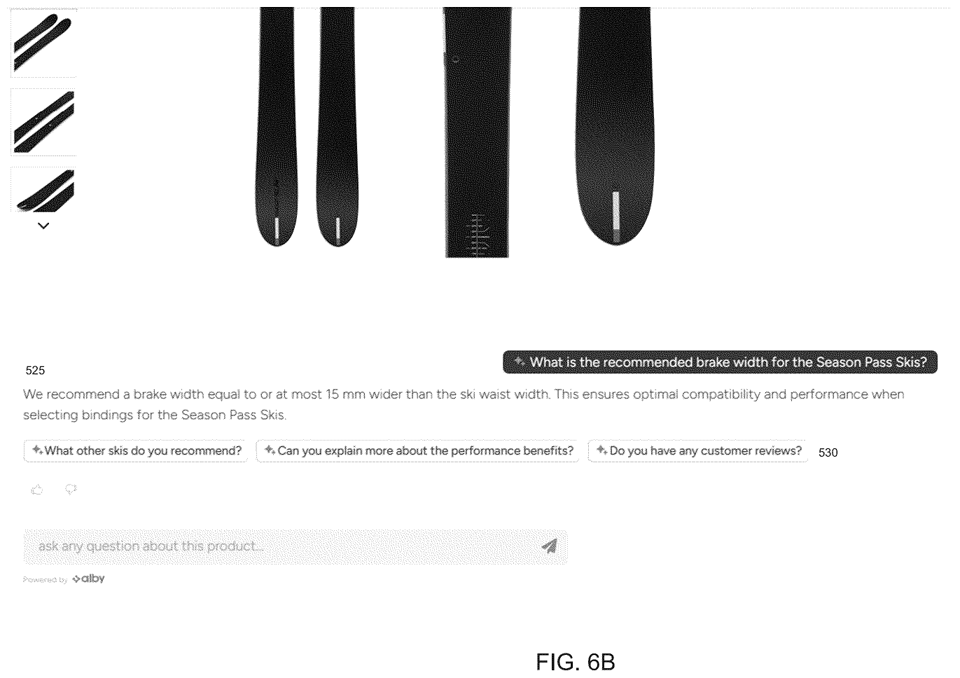

FIGS. 6A and 6B depict a further example of a webpage and application providing the LLM-based generative questions and answers. In FIG. 6A, an initial set of predetermined FAQs 510 are depicted in a widget on a webpage listing a product 505, in this case a pair of skis. The pre-determined FAQs 510 are presented in clickable format. The widget also supports submission of a plain text query 515.

FIG. 6B depicts the appearance of the user interface when any one of the predetermined FAQs 510 are selected, or when a plain text query 515 is submitted. In this case, the question “What is the recommended brake width for the Season Pass Skis?” has been clicked. The LLM generates an answer 525, “We recommend a brake width equal to or at most . . . ”, along with three more follow-up questions 530.

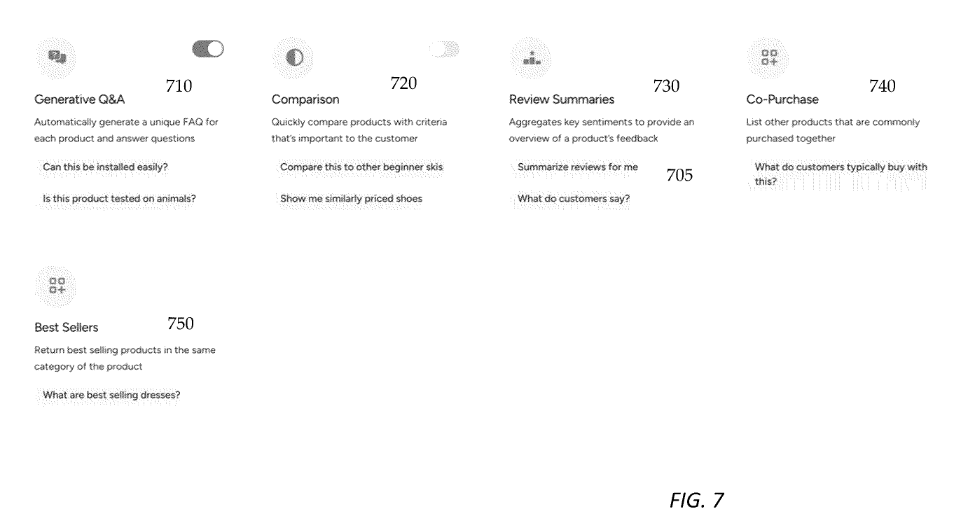

FIG. 7 diagrammatically illustrates exemplary embodiments of skills agents. The skills agents shown include Generative Q&A 710, Generative Comparison 720, Generative Review Summaries 730, Generative Co-Purchase 740, and Generative Best Sellers 750. Each skill agent includes at least one user query 705 in plain text, each of which is paired with a prompt (not shown) to be submitted to the LLM 425.

Under “Generative Review Summaries” 730, the user queries in plain text 705 read “Summarize reviews for me” and “What do customers say”?

Each user query 705 is associated with at least one prompt. For a given skills agent, in some embodiments, multiple user queries 705 are associated with the same prompt. For example, both “Summarize reviews for me” and “What do customers say?” may both be associated with the same prompt, such as:
“Summarize the customer reviews for the product on this page: {Link to product page}.”

In alternative embodiments, user queries 705 are generally associated with unique prompts.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

We claim:

1. A system for generating dynamic search requests and responses for a customer of an ecommerce store, the system comprising:
at least one source database storing context information regarding one or more products listed on the ecommerce store;
at least one user interface element supported by the ecommerce store, the user interface element displayable on a graphical user interface on a user device and configured to receive at least one user query and further configured to populate at least one contextual response to the user query;
at least one server comprising at least one processor and memory for storing instructions executable on the processor, the at least one server communicatively coupled to the user device over a network connection; and
at least one large language model communicatively coupled to the at least one source database and the at least one server, the at least one large language model being trained using data stored in the at least one source database, the at least one large language model being configured to:
generate an initial set of at least one prompt-query pair using the context information for each of the one or more products listed on the ecommerce store;
receive the at least one user query from the user device, the user query comprising a user selection of a query, the query being associated with at least one pre-configured prompt for the at least one large language model;
generate and display the contextual response to the prompt-query pair using the pre-configured prompt, the at least one user query, and the information regarding the product stored in the at least one source database.

2. The system of claim 1, the dynamic search requests comprising any of the following: frequently asked questions; product comparisons; summaries of customer reviews; suggested co-purchases; and lists of best-selling products.

3. The system of claim 1, the user interface element comprising any of the following: a webpage component, a mobile application component, and a web component displayed in the body of an email.

4. The system of claim 1, the at least one prompt-query pair being submitted as a clickable link having the text of the at least one product-related query.

5. The system of claim 1, further comprising a conversation agent configured to record a customer's browse behavior on an ecommerce store and an identifier of the customer.

6. The system of claim 5, the large language model further configured to generate the contextual response to the at least one prompt-query pair based on the customer's browse behavior and the identifier as recorded by the conversation agent.

7. The system of claim 1, further comprising:
A caching means communicatively coupled to the server, the caching means configured to cache the plurality of prompt-query pairs and the contextual responses associated with each of the prompt-query pairs; and
a retrieval unit configured to fetch cached contextual responses and display the cached contextual responses without invoking the large language model.

8. The system of claim 1, the configuring of the large language model including training the large language model, at least in part, by:
collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer-posted questions and answers to the customer-posted questions from other customers or from online sellers;
processing the training data to create training prompts simulating real-world scenarios where a hypothetical customer seeks product-related information based on the hypothetical customer's history and context;
training the large language model using the training prompts to predict most likely queries the hypothetical customer might have about a product; and
refining the large language model's predictions using feedback received from actual customer interactions on the ecommerce store.

9. The system of claim 8, the training data further comprising customer browse behavior, customer context information, and customer queries related to one or more of the products.

10. The system of claim 1, further comprising a scoring means for determination of an optimal subset of prompts to feature within the user interface element, the determination being based at least in part on input comprising at least one of: sales trends, browse rate, click rate, add-to-cart rate, remove-from-cart rate, browse-to-purchase ratio, and click-to-purchase ratio.

11. A method for generating dynamic search requests and responses for a customer of an ecommerce store, the method comprising:
training a large language model using context information stored in at least one source database, the information pertaining to one or more products listed by the ecommerce store;
preparing at least one pre-configured prompt for a contextual response and associating the at least one pre-configured prompt to at least one user query by the large language model;
generating an initial set of at least one prompt-query pair using the context information for each of the one or more products listed on the ecommerce store, the prompt-query pair comprising the at least one pre-configured prompt and the at least one user query;
receiving the at least one prompt-query pair regarding at least one of the one or more products, the at least one prompt-query pair being submitted by a user interface element supported by the ecommerce store, the user interface element configured to populate a contextual response to the at least one prompt-query pair, the user interface element displayed on a user device communicatively coupled with the large language model by way of at least one server; and
generating, by the large language model, the contextual response to the at least one prompt-query pair using the pre-configured prompt and the information regarding the product stored in the at least one source database.

12. The method of claim 11, the dynamic search requests comprising any of the following: frequently asked questions; product comparisons; summaries of customer reviews; suggested co-purchases; and lists of best-selling products.

13. The method of claim 11, the user interface element comprising any of the following: a webpage component, a mobile application component, and a web component displayed in the body of an email.

14. The method of claim 11, the at least one prompt-query pair being submitted as a clickable link having the text of the at least one product-related query.

15. The method of claim 11, further comprising receiving, from the at least one source database, a customer's browse behavior on the ecommerce store and an identifier of the customer.

16. The method of claim 15, further comprising generating, by the large language model, the contextual response to the at least one user query based on the customer's browse behavior and the identifier.

17. The method of claim 11, further comprising:
caching the plurality of prompt-query pairs and the contextual responses associated with each of the prompt-query pairs by way of a caching means communicatively coupled to the server; and
retrieving and displaying cached contextual responses for the plurality of prompt-query pairs without invoking the large language model.

18. The method of claim 11, the configuring of the large language model including training the large language model, at least in part, by:
collecting training data comprising one or more of: product details posted on a page on the ecommerce store, including but not limited to the product page itself; articles, blogs, and content available online regarding the product; purchasing guides with information regarding specifications, such as sizing, dimensions, and customization options; product image information; customer reviews and feedback, including written reviews and ratings; and customer questions and answers to customer questions from other customers or from online sellers;
processing the training data to create training prompts simulating real-world scenarios where a hypothetical customer seeks product-related information based on the hypothetical customer's history and context;
training the large language model using the training prompts to predict the most likely queries the hypothetical customer might have about the product; and
refining the large language model's predictions using feedback received from actual customer interactions on the ecommerce store.

19. The method of claim 18, the training data further comprising customer browse behavior, customer context information, and customer queries related to one or more of the products.

20. The method of claim 11, further comprising determining, by a scoring agent, an optimal set of questions to feature as a subset within the user interface element, the determination being based at least in part on input comprising at least one of: sales trends, browse rate, click rate, add-to-cart rate, remove-from-cart rate, browse-to-purchase ratio, and click-to-purchase ratio.

21. A method for displaying dynamic search requests and responses for a customer of an ecommerce store, the method comprising:
configuring a user interface element displayable on a graphical user interface to receive at least one user query associated with at least one pre-configured prompt and to populate at least one contextual response to the user query and the at least one pre-configured prompt;
receiving, by a server, at least one prompt-query pair comprising the at least one user query and the at least one prompt, the at least one prompt-query pair submitted on a user device communicatively coupled to the server, the server comprising a processor and a memory for storing instructions executable on the processor, the server further communicatively coupled to a large language model configured by:
training the large language model using context information stored in at least one source database, the context information pertaining to one or more products listed on the ecommerce store;
generating an initial set of at least one prompt-query pair using the context information for each of the one or more products listed on the ecommerce store;
preparing, by the large language model, a contextual response to the at least one prompt-query pair using the pre-configured prompt and the information regarding the product stored in the at least one source database; and
generating, by the large language model at least one predicted follow-up question; and
displaying the contextual response and the at least one predicted follow-up question in the user interface element.
